(19) United States
(12) Patent Application Publication
(10) Pub. No.: US 2026/0247182 A1
(43) Pub. Date: Aug. 20, 2026

(54) BEAM MEASUREMENT METHOD AND APPARATUS, DEVICE AND STORAGE MEDIUM

(71) Applicant: BEIJING XIAOMI MOBILE SOFTWARE CO., LTD., Beijing (CN)

(72) Inventor: Liangang CHI, Beijing (CN)

(21) Appl. No.: 19/160,978

(22) PCT Filed: Mar. 3, 2023
(86) PCT No.: PCT/CN2023/079683

§ 371 Date: Aug. 29, 2025

(51) Int. Cl. H04W 24/08

(52) U.S. Cl. CPC H04W 24/08

(57) ABSTRACT

A method for measuring a beam, including: sending at least two pieces of reference signal configuration information to a terminal, wherein different reference signal configuration information is used to configure at least one reference signal on different frequency bands; receiving measurement results, reported by the terminal, of the reference signals on the different frequency bands; and sending updated reference signal configuration information to the terminal, wherein the updated reference signal configuration information is determined based on a measurement range of reference signals on a second frequency band, the measurement range of the reference signals on the second frequency band is determined based on measurement results of reference signals on a first frequency band, the first frequency band comprises at least one frequency band from the different frequency bands, and the second frequency band comprises at least one frequency band from the different frequency bands excluding the first frequency band.

### CROSS-REFERENCE TO RELATED APPLICATION

The present application is a U.S. National Stage of International Application No. PCT/CN2023/079683, filed on Mar. 3, 2023, the contents of all of which are incorporated herein by reference in their entirety for all purposes.

### BACKGROUND OF THE INVENTION

Millimeter-wave spectrum, due to its abundant idle spectral resources, can effectively meet the demands for higher capacity and speed in future communication systems, and consequently, is widely applied.

### SUMMARY OF THE INVENTION

The present disclosure relates to the technical field of communication, and in particular, to a method and device for measuring a beam, a device, and a storage medium.

In a first aspect, a method for measuring a beam is provided. The method is performed by a network device, and includes:
sending at least two pieces of reference signal configuration information to a terminal, where different reference signal configuration information is used to configure at least one reference signal on different frequency bands;
receiving measurement results, reported by the terminal, of the reference signals on the different frequency bands; and
sending updated reference signal configuration information to the terminal, where the updated reference signal configuration information is determined based on a measurement range of reference signals on a second frequency band, the measurement range of the reference signals on the second frequency band is determined based on measurement results of reference signals on a first frequency band, the first frequency band includes at least one frequency band from the different frequency bands, and the second frequency band includes at least one frequency band from the different frequency bands excluding the first frequency band.

In a second aspect, a method for measuring a beam is provided. The method is performed by a terminal and includes:
receiving at least two pieces of reference signal configuration information sent by a network device, where different reference signal configuration information is used to configure at least one reference signal on different frequency bands;
reporting measurement results of the reference signals on the different frequency bands to the network device; and
receiving updated reference signal configuration information sent by the network device.

In a third aspect, a communication device is provided. The communication device includes:
a transceiver module configured to send at least two pieces of reference signal configuration information to a terminal, where different reference signal configuration information is used to configure at least one reference signal on different frequency bands;
the transceiver module is further configured to receive measurement results, reported by the terminal, of the reference signals on the different frequency bands; and
the transceiver module is further configured to send updated reference signal configuration information to the terminal, where the updated reference signal configuration information is determined based on a measurement range of reference signals on a second frequency band, the measurement range of the reference signals on the second frequency band is determined based on measurement results of reference signals on a first frequency band, the first frequency band includes at least one frequency band from the different frequency bands, and the second frequency band includes at least one frequency band from the different frequency bands excluding the first frequency band.

In a fourth aspect, a communication device is provided. The communication device includes:
a transceiver module configured to receive at least two pieces of reference signal configuration information sent by a network device, where different reference signal configuration information is used to configure at least one reference signal on different frequency bands;
the transceiver module is further configured to report measurement results of the reference signals on the different frequency bands to the network device; and
the transceiver module is further configured to receive updated reference signal configuration information sent by the network device.

In a fifth aspect, a communication device is provided. The communication device includes one or more processors, where the one or more processors, when collectively calling a computer program in a memory, perform the method according to any of the first aspect or the second aspect.

In a sixth aspect, a communication device is provided. The communication device includes one or more processors and an interface circuit. The interface circuit is configured to receive code instructions and transmit the code instructions to the one or more processors. The one or more processors, when collectively running the code instructions, cause the communication device to perform the method according to any of the first aspect or the second aspect.

In a seventh aspect, a communication system is provided. The communication system includes the communication device according to any of the third aspect or the fourth aspect, or the communication device described in the fifth aspect, or the communication device described in the sixth aspect.

In an eighth aspect, a non-transitory computer-readable storage medium is provided. The non-transitory computer-readable storage medium stores instructions used by the network device or the terminal of other aspects, where the instructions, when executed, cause the terminal to perform the method according to the second aspect or cause the network device to perform the method according to the first aspect.

In a ninth aspect, a computer program product including a computer program is provided, where the computer program, when running on a computer, causes the computer to perform the method according to any of the first aspect or the second aspect.

In a tenth aspect, a chip system is provided. The chip system includes at least one processor and an interface for supporting a network device to perform functions involved in the method according to the first aspect or supporting a terminal to perform functions involved in the method according to the second aspect, such as determining or processing at least one of data or information involved in the method. In a design, the chip system further includes a memory storing a computer program and data that are needed for source and secondary nodes. The chip system may be composed of a chip, or may also include a chip and other discrete components.

In an eleventh aspect, a computer program is provided, where the computer program, when running on a computer, causes the computer to perform the method according to any of the first aspect or the second aspect.

### BRIEF DESCRIPTION OF DRAWINGS

The above-mentioned and/or additional aspects and benefits of the present disclosure will become apparent and easy to understand from the following descriptions of embodiments in combination with the accompanying drawings.

FIG. 1 is a schematic diagram of an architecture of a communication system according to an embodiment of the present disclosure.

FIG. 2 is a schematic flowchart of a method for measuring a beam according to an embodiment of the present disclosure.

FIG. 3a is a schematic flowchart of a method for measuring a beam according to an embodiment of the present disclosure.

FIG. 3b is a schematic flowchart of a method for measuring a beam according to an embodiment of the present disclosure.

FIG. 4 is a schematic flowchart of a method for measuring a beam according to another embodiment of the present disclosure.

FIG. 5 is a schematic flowchart of a method for measuring a beam according to another embodiment of the present disclosure.

FIG. 6 is a schematic flowchart of a method for measuring a beam according to another embodiment of the present disclosure.

FIG. 7 is a schematic flowchart of a method for measuring a beam according to another embodiment of the present disclosure.

FIG. 8 is a schematic flowchart of a method for measuring a beam according to another embodiment of the present disclosure.

FIG. 9 is a schematic flowchart of a method for measuring a beam according to another embodiment of the present disclosure.

FIG. 10 is a schematic flowchart of a method for measuring a beam according to another embodiment of the present disclosure.

FIG. 11 is a schematic flowchart of a method for measuring a beam according to another embodiment of the present disclosure.

FIG. 12 is a schematic structural diagram of a communication device according to yet another embodiment of the present disclosure.

FIG. 13 is a schematic structural diagram of a communication device according to yet another embodiment of the present disclosure.

FIG. 14 is a schematic structural diagram of a communication device according to an embodiment of the application.

FIG. 15 is a schematic structural diagram of a chip according to an embodiment of the present disclosure.

### DETAILED DESCRIPTION OF THE INVENTION

Examples are described in detail below, as illustrated in the accompanying drawings. In the following description involving the accompanying drawings, unless otherwise indicated, the same numerals in different accompanying drawings represent the same or similar elements. Implementations described in the following examples do not represent all implementations consistent with the embodiments of the present disclosure. On the contrary, they are merely examples of devices and methods consistent with some aspects of the embodiments of the present disclosure as described in detail in the appended claims.

The terms used in the embodiments of the present disclosure are merely intended for the purpose of describing specific embodiments and are not intended to limit the embodiments of the present disclosure. Singular forms “a/an” and “the” used in the embodiments of the present disclosure and the appended claims are also intended to include plural forms, unless the context clearly indicates otherwise. It is also to be understood that the term “and/or” used in the specification refers to and includes any or all possible combinations of one or more of associated listed items.

It is to be understood that although the terms such as first, second, and third may be used to describe various types of information in the embodiments of the present disclosure, such information is not to be limited to these terms. These terms are merely used to distinguish signals of the same type from one another. For example, first information may also be referred to as second information, and similarly, the second information may also be referred to as the first information, without departing from the scope of the embodiments of the present disclosure. Depending on the context, the terms “if” and “in case of” as used herein may be interpreted as “when” or “upon” or “in response to determining”.

The embodiments of the present disclosure are described in detail below, and examples of the embodiments are shown in accompanying drawings, where the same or similar reference numerals denote the same or similar elements throughout. The embodiments described below with reference to the accompanying drawings are illustrative, and are intended to explain the present disclosure rather than to be construed as a limitation to the present disclosure.

Millimeter-wave spectrum, due to its abundant idle spectral resources, can effectively meet the demands for higher capacity and speed in future communication systems, and consequently, is widely applied. The path loss during signal propagation is much greater than the path loss for a low-frequency band spectrum, when the millimeter-wave spectrum is used for communication. To compensate for the path loss in millimeter-wave and terahertz communications, narrow beams are typically employed for signal transmission. How to achieve precise beam tracking and rapid beam recovery is a pressing problem that needs to be solved currently, when the narrow beams are used for signal transmission.

For a better understanding of a method for measuring a beam disclosed in embodiments of the present disclosure, a communication system applicable to the embodiments of the present disclosure is first described below.

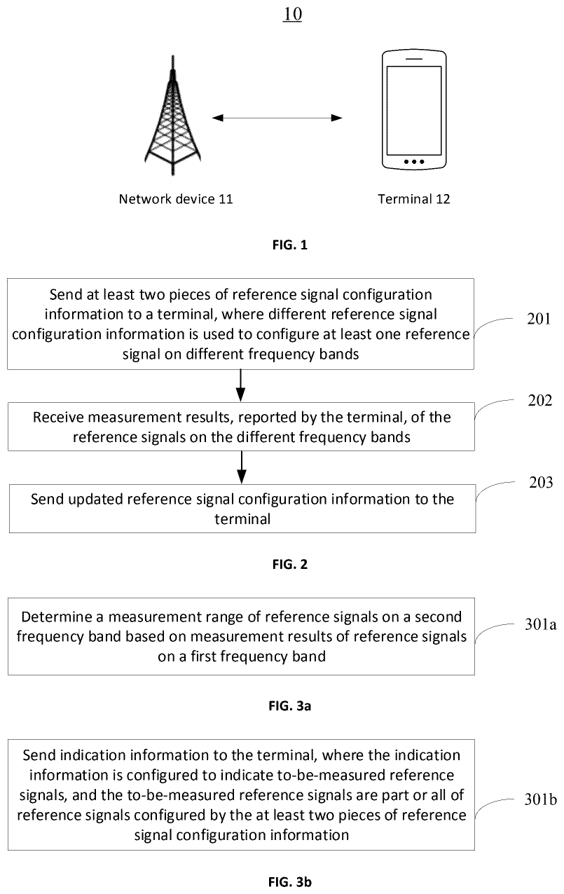

Referring to FIG. 1, FIG. 1 is a schematic diagram of an architecture of a communication system according to an embodiment of the present disclosure. The communication system 10 may include, but is not limited to, a network device 11 and a terminal 12. The number and form of devices shown in FIG. 1 are for illustrative purposes and do not constitute limitations to the embodiments of the present disclosure. In practical applications, one or more network devices or one or more terminals may be included. In an example, the communication system 10 shown in FIG. 1 includes one network device 11 and one terminal 12 as an example.

It is to be noted that the technical solutions of the embodiments of the present disclosure may be applied to various communication systems, such as a long term evolution (LTE) system, a 5th generation (5G) mobile communication system, a 5G new radio (NR) system, or other future novel mobile communication systems.

The terminal in the embodiment of the present disclosure may be a user-side entity for receiving or transmitting a signal, such as a mobile phone, or may also be referred to as a terminal, user equipment (UE), a mobile station (MS), a mobile terminal (MT), etc. The terminal may be a vehicle with a communication function, a smart vehicle, a mobile phone, a wearable device, a Pad, a computer with a wireless transceiver function, a virtual reality (VR) terminal, an augmented reality (AR) terminal, a wireless terminal in industrial control, a wireless terminal in self-driving, a wireless terminal in remote medical surgery, a wireless terminal in a smart grid, a wireless terminal in transportation safety, a wireless terminal in a smart city, a wireless terminal in a smart home, or the like. The embodiment of the present disclosure imposes no restriction on specific technologies and specific device forms adopted in the terminal.

The network device (i.e., a first network device or a second network device) in the embodiment of the present disclosure may be a network-side entity for transmitting or receiving a signal. For example, the network device may be an evolved NodeB (eNB), a transmission reception point (TRP), a next generation NodeB (gNB) in an NR system, a base station in other future mobile communication systems, an access node in a wireless fidelity (Wi-Fi) system, or the like. The embodiment of the present disclosure imposes no restriction on specific technologies and specific device forms adopted in the network device. The network device provided in the embodiment of the present disclosure may be composed of a central unit (CU) and distributed units (DUs), where the CU may also be referred to as a control unit. The use of a CU-DU structure may allow a protocol layer of the network device, such as a base station, to be separated. Some functions of the protocol layer are centrally controlled in the CU, while some or all of the remaining functions of the protocol layer are distributed in the DUs, and the CU centrally controls the DUs.

It is to be understood that the communication system described in the embodiment of the present disclosure is intended to provide a clearer description of the technical solution of the embodiment of the present disclosure and does not constitute limitations to the technical solution provided in the embodiment of the present disclosure. Those of ordinary skill in the art may understand that as the system architecture evolves and new service scenarios emerge, the technical solution provided in the embodiment of the present disclosure is equally applicable to similar technical problems.

A method and device for measuring a beam, a device, and a storage medium provided in the embodiments of the present disclosure are described in detail below with reference to the accompanying drawings.

It is to be noted that in the present disclosure, each step in any implementation or embodiment may be implemented as an independent embodiment, and the steps may be combined arbitrarily, in a case of no contradiction. For example, a solution where some steps are removed from a certain implementation or embodiment may also be implemented as an independent embodiment. Moreover, the order of steps in a certain implementation or embodiment may be exchanged arbitrarily. Additionally, optional methods or examples in a certain implementation or embodiment may be combined arbitrarily. Further, various implementations or embodiments may be combined arbitrarily, for example, part or all of steps from different implementations or embodiments may be combined arbitrarily, or a certain implementation or embodiment may be combined with optional methods or examples from other implementations or embodiments arbitrarily. For expressions used in the present disclosure such as “A or B,” “A and/or B,” “at least one of A or B,” “A in one case, and B in another case,” “in a case where A, and in another case where B,” depending on the circumference, at least one of the following solutions may be included: A is performed regardless of B, namely, A in some implementations; B is performed regardless of A, namely, B in some implementations; A or B is selectively performed, namely, either A or B is chosen to be performed in some implementations; or both A and B are performed, namely, A and B in some implementations. Additionally, each element, row, or column in tables involved in the present disclosure may be implemented as an independent embodiment, and a combination of any elements, rows, and columns may also be implemented as an independent embodiment.

FIG. 2 is a schematic flowchart of a method for measuring a beam according to an embodiment of the present disclosure. The method is performed by a network device. As shown in FIG. 2, the method for measuring the beam may include steps 201 to 203.

In step 201, at least two pieces of reference signal configuration information are sent to a terminal, where different reference signal configuration information is used to configure at least one reference signal on different frequency bands.

In an embodiment of the present disclosure, the reference signal configuration information is used to configure a reference signal to be transmitted by the network device to the terminal. For example, the reference signal configuration information may include at least one of the following:
a frequency band where the reference signal is located;
a time-domain position of the reference signal;
a frequency-domain position of the reference signal;
sequence information of the reference signal;
an identifier of the reference signal; or
a beam identifier of a transmission beam for the reference signal.

In an embodiment of the present disclosure, the network device sends the reference signal configuration information to the terminal, enabling the terminal to successfully receive, based on the reference signal configuration information, the reference signal transmitted by the network device, and the terminal may then measure this reference signal to ensure the smooth progress of subsequent processes.

In step 202, measurement results, reported by the terminal, of the reference signals on the different frequency bands are received.

In an embodiment of the present disclosure, the measurement results, reported by the terminal, of the reference signals on the different frequency bands may be obtained by measuring, after the terminal receives the reference signals based on the at least two pieces of reference signal configuration information, the received reference signals.

In an embodiment of the present disclosure, it may be defaulted or agreed by a protocol that the terminal needs to measure all reference signals configured by the at least two pieces of reference signal configuration information (i.e., the reference signals configured by the at least two pieces of reference signal configuration information are regarded as to-be-measured reference signals). In this case, the terminal may receive all configured reference signals based on the at least two pieces of reference signal configuration information, upon receiving the at least two pieces of reference signal configuration information. For example, the terminal may receive, based on the sequence information of each reference signal in each piece of reference signal configuration information, all reference signals configured by the network device at the time-domain position and the frequency-domain position of each reference signal, obtains the measurement results by measuring all the reference signals, and then, reports the measurement results to the network device.

In another embodiment of the present disclosure, the network device may indicate to-be-measured reference signals to the terminal. In an example, the network device may send indication information to the terminal, and the indication information is configured to indicate the to-be-measured reference signals. The to-be-measured reference signals are part or all of the reference signals configured by the at least two pieces of reference signal configuration information (i.e., the to-be-measured reference signals constitute a full set or subset of the reference signals configured by the at least two pieces of reference signal configuration information). The indication information includes at least one of the following: a time-domain position of the to-be-measured reference signal; a frequency-domain position of the to-be-measured reference signal; an identifier of the to-be-measured reference signal; or a beam identifier of a transmission beam for the to-be-measured reference signal. Moreover, the terminal, upon receiving the indication information, may determine the to-be-measured reference signals for the terminal based on the indication information, receive the to-be-measured reference signals based on reference signal configuration information corresponding to the to-be-measured reference signals, obtain the measurement results by measuring the to-be-measured reference signals, and then, report the measurement results to the network device.

In an embodiment of the present disclosure, the terminal may measure the reference signal and report the measurement result based on a report configuration, when measuring the reference signal and reporting the measurement result. In an embodiment of the present disclosure, the network device may configure the report configuration for the terminal. The report configuration may include at least one of the following:
a report condition (e.g., the measurement result is greater than a certain threshold);
a to-be-measured measurement result (e.g., the measurement result may be at least one of a reference signal received power (RSRP), a reference signal received quality (RSRQ), a signal-to-interference plus noise ratio (SINR), or a received signal strength indication (RSSI)); or
a time-frequency resource occupied when reporting the measurement result.

In an example, the terminal may measure, based on the report configuration, the to-be-measured measurement result when measuring the reference signal, and then, may report the measurement result to the network device on the time-frequency resource occupied when reporting the measurement result, in a case where the measurement result meets the report condition.

In step 203, updated reference signal configuration information is sent to the terminal.

In an embodiment of the present disclosure, the updated reference signal configuration information may be determined based on a measurement range of reference signals on a second frequency band, and the measurement range of the reference signals on the second frequency band may be determined based on measurement results of reference signals on a first frequency band. In an embodiment of the present disclosure, the first frequency band may include at least one frequency band from the different frequency bands, and the second frequency band may be at least one frequency band from the different frequency bands excluding the first frequency band. In an example, the “measurement range of the reference signals on the second frequency band” may be understood as to-be-measured reference signals on the second frequency band.

In an embodiment of the present disclosure, the network device, upon receiving the measurement results, reported by the terminal, of the reference signals on the different frequency bands in step 202, may first determine the measurement results of the reference signals on the first frequency band from the measurement results of the reference signals on the different frequency bands, determines the measurement range of the reference signals on the second frequency band based on the measurement results of the reference signals on the first frequency band, and then, determines the updated reference signal configuration information based on the measurement range of the reference signals on the second frequency band.

In an example, the network device may determine, with reference to an association relationship between the reference signals on the first frequency band and the reference signals on the second frequency band, the measurement range of the reference signals on the second frequency band based on the measurement results of the reference signals on the first frequency band. In an embodiment of the present disclosure, the reference signals on the different frequency bands all have an association relationship, where coverage ranges of associated reference signals on the different frequency bands are mutually matched. In an example, the “coverage ranges of the associated reference signals are mutually matched” may be understood as follows: in a case where a coverage range of a certain reference signal on a certain frequency band includes a coverage range of a certain reference signal on another frequency band, it is considered that the two reference signals have an association relationship; or, in a case where a coverage range of a reference signal on a frequency band is included within a coverage range of a reference signal on another frequency band, it is considered that the two reference signals have an association relationship.

It is to be noted that, in an embodiment of the present disclosure, a wider coverage range of the reference signals on low-frequency bands is brought due to the adoption of a wide beam to send the reference signals on the low-frequency bands, while a narrower coverage range of the reference signals on high-frequency bands is brought due to the adoption of a narrow beam to send the reference signals on the high-frequency bands. As a result, the coverage range of one reference signal on the low-frequency bands may include the coverage range of at least one reference signal on the high-frequency bands, and consequently, an association relationship is established between one reference signal on the low-frequency bands and one or more reference signals on the high-frequency bands.

In an embodiment of the present disclosure, the association relationship between the reference signals on the different frequency bands may be pre-determined. The association relationship between the reference signals on the different frequency bands may be determined through at least one of the following modes:

Mode 1: the association relationship between the reference signals on the different frequency bands is determined based on transmission angles of the reference signals on the different frequency bands.

In an embodiment of the present disclosure, the transmission angles of the reference signals may indicate coverage ranges of the reference signals. Regarding the “transmission angles of the reference signals”, it is considered that the coverage ranges of two reference signals completely overlap, in a case where a transmission angle of one reference signal includes a transmission angle of another reference signal. In this case, it may be considered that the two reference signals have an association relationship.

For example, it is assumed that the transmission angle of a reference signal #1 on the first frequency band is 0° to 30°, the transmission angle of a reference signal #2 on the second frequency band is 0° to 10°, the transmission angle of a reference signal #3 on the second frequency band is 10° to 20°, and the transmission angle of a reference signal #4 on the second frequency band is 20° to 30°. In this case, the transmission angle of the reference signal #1 includes the transmission angle of the reference signal #2, the transmission angle of the reference signal #3, and the transmission angle of the reference signal #4, and consequently, it is considered that the coverage range of the reference signal #1 includes the coverage range of the reference signal #2, the coverage range of the reference signal #3, and the coverage range of the reference signal #4. As a result, it is determined that the reference signal #1 on the first frequency band has an association relationship with the reference signal #2, the reference signal #3, and the reference signal #4 on the second frequency band.

Mode 2: the association relationship between the reference signals on the different frequency bands is determined based on historical measurement results of the reference signals on the different frequency bands.

In an embodiment of the present disclosure, reference signals with better measurement results on different frequency bands during a same time period may have an association relationship. For example, during a same time period, the reference signals merely in a certain area (e.g., a nearby area where the terminal is located) may have the best transmission quality, resulting in better measurement results for the reference signals within this area. Based on this, reference signals with better measurement results on different frequency bands during a same time period are likely to be located in this area. In other words, coverage ranges of the reference signals with better measurement results on the different frequency bands during a same time period may highly overlap. In this case, these reference signals may be bound in terms of their association relationships.

From the above-mentioned content, it can be seen that, in an embodiment of the present disclosure, the network device may collect the historical measurement results of the reference signals on the different frequency bands, and bind, based on the historical measurement results of the reference signals on the different frequency bands, the reference signals with better measurement results on the different frequency bands during a same time period in terms of their association relationship. As a result, the association relationship between the reference signals on the different frequency bands is determined.

For example, it is assumed that the first frequency band is lower than the second frequency band, the first frequency band includes a reference signal #1 and a reference signal #2, and the second frequency band includes a reference signal #3, a reference signal #4, a reference signal #5, a reference signal #6, and a reference signal #7. During a same time period, the reference signal #1 on the first frequency band has the best measurement result, and the reference signal #3, the reference signal #6, and the reference signal #7 on the second frequency band have the best measurement results. In this case, it may be considered that the reference signal #1, the reference signal #3, the reference signal #6, and the reference signal #7 are located in a same area, meaning that the coverage range of the reference signal #1 includes the coverage ranges of the reference signal #3, the reference signal #6, and the reference signal #7. As a result, it may be determined that the reference signal #1 on the first frequency band has an association relationship with the reference signal #3, the reference signal #6, and the reference signal #7 on the second frequency band.

In an embodiment of the present disclosure, after determining the association relationship between the reference signals on the different frequency bands, the measurement range of the reference signals on the second frequency band may be determined based on the measurement results of the reference signals on the first frequency band and with reference to the association relationship. It is to be noted that, in an embodiment of the present disclosure, a method for determining the measurement range of the reference signals on the second frequency band based on the measurement results of the reference signals on the first frequency band may also be different, in a case where a size relationship between the first frequency band and the second frequency band is different.

In an embodiment of the present disclosure, the method for “determining the measurement range of the reference signals on the second frequency band based on the measurement results of the reference signals on the first frequency band” may include the following steps a and b (not shown), in a case where the first frequency band is lower than the second frequency band, meaning that the first frequency band is a low-frequency band and the second frequency band is a high-frequency band.

In step a, a reference signal with a measurement result meeting a preset condition on the first frequency band is determined as a target reference signal.

In an embodiment of the present disclosure, the preset condition may include at least one of the following:
a reference signal with a best measurement result; or
a reference signal with a measurement result greater than a preset threshold.

Further, in a case where the first frequency band is the low-frequency band, reference signals on the first frequency band are signals having a wider coverage range, namely, reference signals transmitted through a wide beam.

From the above-mentioned content, it can be seen that the target reference signal determined in step a is fundamentally a reference signal, transmitted through the wide beam and having a better measurement result, on the low-frequency band.

In step b, the measurement range of the reference signals on the second frequency band is determined as reference signals, having an association relationship with the target reference signal, on the second frequency band.

In an example, the “reference signals, having the association relationship with the target reference signal, on the second frequency band” may be understood as reference signals, with coverage ranges falling within a same area as the coverage range of the target reference signal and transmitted through a narrow beam, on the second frequency band.

Moreover, from the steps a and b, it can be seen that the reference signals on the first frequency band are transmitted through the wide beam and have the wider coverage range, while the reference signals on the second frequency band are transmitted through the narrow beam and have the narrower coverage range, in a case where the first frequency band is lower than the second frequency band. Based on this, in an embodiment of the present disclosure, reference signals (i.e., the wide beam) with better measurement results on the low-frequency band are determined by performing step a firstly, and consequently, an area with higher beam quality is located to achieve coarse beam tracking. Subsequently, the measurement range of the reference signals (i.e., the narrow beam) on the high-frequency band is adjusted by performing step b, enabling the measurement range of the reference signals (i.e., the narrow beam) on the high-frequency band to fall within the coverage range of the reference signals (i.e., the wide beam) with better measurement results on the low-frequency band. Accordingly, a transmission beam (i.e., the narrow beam) for the reference signal with the best measurement result is selected from the measurement range of the reference signals (i.e., the narrow beam) on the high-frequency band as a target beam. In other words, the narrow beam with the highest beam quality is further selected from the previously located area with higher beam quality, achieving rapid and fine beam tracking.

For example, it is assumed that the reference signals on the first frequency band include reference signals #A1 to #A4, and the reference signals on the second frequency band include reference signals #B1 to #B20, where the reference signal #A1 has an association relationship with the reference signals #B1 to #B5, the reference signal #A2 has an association relationship with the reference signals #B6 to #B10, the reference signal #A3 has an association relationship with the reference signals #B11 to #B15, and the reference signal #A4 has an association relationship with the reference signals #B16 to #B20. In this case, the measurement range of the reference signals on the second frequency band may be determined as the reference signals #B6 to #B10, in a case where the reference signal with the best measurement result on the first frequency band is determined as the reference signal #A2.

In another embodiment of the present disclosure, the method for “determining the measurement range of the reference signals on the second frequency band based on the measurement results of the reference signals on the first frequency band” may include the following steps 1 and 2 (not shown), in a case where the first frequency band is higher than the second frequency band, meaning that the first frequency band is a high-frequency band and the second frequency band is a low-frequency band.

In step 1, a reference signal with a measurement result meeting a preset condition on the first frequency band is determined as a first target reference signal.

In an embodiment of the present disclosure, the preset condition may include at least one of the following:
a reference signal with a best measurement result; or
a reference signal with a measurement result greater than a preset threshold.

Further, reference signals on the first frequency band are signals having a narrower coverage range, namely, reference signals transmitted through a narrow beam, in a case where the first frequency band is the high-frequency band.

From the above-mentioned content, it can be seen that the first target reference signal determined in step 1 is a reference signal, having a better measurement result and transmitted through the narrow beam, on the high-frequency band. It may be considered that the terminal is currently within the coverage range of this first target reference signal.

In step 2, in a case where a distance between a boundary of a coverage range of the first target reference signal and a boundary of a coverage range of a second target reference signal associated with the first target reference signal on the second frequency band is less than a first threshold, a third target reference signal, with a distance between its coverage range and the coverage range of the first target reference signal or the second target reference signal less than a second threshold, on the second frequency band is determined based on an association relationship between the reference signals on the different frequency bands, and a measurement range of the reference signals on the second frequency band is determined as at least one of the second target reference signal on the second frequency band or the third target reference signal on the second frequency band.

In an example, from the content of step 2, it can be seen that the second target reference signal is a signal on the second frequency band, while the first target reference signal is a signal on the first frequency band. Since the first frequency band is the high-frequency band and the second frequency band is the low-frequency band, the coverage range of the first target reference signal on the first frequency band is smaller than the coverage range of the second target reference signal on the second frequency band. In this case, it is concluded that the coverage range of the second target reference signal includes the coverage range of the first target reference signal, due to the presence of an association relationship between the first target reference signal and the second target reference signal. Based on this, it is further concluded that the terminal is currently also within the coverage range of the second target reference signal, due to the terminal currently falling within the coverage range of the first target reference signal.

In an embodiment of the present disclosure, “the distance between the boundary of the coverage range of the first target reference signal and the boundary of the coverage range of the second target reference signal associated with the first target reference signal on the second frequency band” in step 2 may be understood as follows: the coverage range of the first target reference signal is close to the boundary of the coverage range of the second target reference signal associated with the first target reference signal on the second frequency band (i.e., the low-frequency band), meaning that the terminal is currently located at the boundary of the coverage range of the second target reference signal on the second frequency band (i.e., the low frequency band), and that the terminal may move out of the coverage range of the second target reference signal on the second frequency band (i.e., the low-frequency band) in a next time period. As a result, in a case of determining the measurement range of the reference signals on the second frequency band, a reference signal (i.e., the third target reference signal), whose coverage range includes a potential position of the terminal in the next time period, on the second frequency band may be determined as the measurement range of the reference signals on the second frequency band, to achieve precise beam tracking.

In this case, a movement direction of the terminal may first be determined. For example, the movement direction of the terminal may be determined based on a reference signal with a better previous measurement result on the first frequency band (i.e., the high-frequency band) and the first target reference signal (i.e., a reference signal with a better current measurement result on the first frequency band (i.e., the high-frequency band)). Subsequently, the potential position of the terminal in the next time period is determined based on the movement direction of the terminal, and then, the third target reference signal, whose coverage range includes the potential position of the terminal in the next time period, on the second frequency band is determined. In an embodiment of the present disclosure, the third target reference signal may be a reference signal, with a distance between its coverage range and the coverage range of the first target reference signal on the first frequency band (i.e., the high-frequency band) less than the second threshold, on the second frequency band (i.e., the low-frequency band), namely, a reference signal, whose coverage range is close to the coverage range of the first target reference signal, on the second frequency band (i.e., the low-frequency band). Alternatively, the third target reference signal may be a reference signal, with a distance between its coverage range and the coverage range of the second target reference signal less than the second threshold, on the second frequency band (i.e., the low-frequency band) in the movement direction of the terminal, such as a reference signal, whose coverage range is close to the coverage range of the second target reference signal, on the second frequency band (i.e., the low-frequency band) in the movement direction of the terminal.

For example, the following is a detailed example of introducing the method for determining the second target reference signal and the third target reference signal. In an embodiment of the present disclosure, in a case where the first frequency band is higher than the second frequency band, it is assumed that the reference signals on the second frequency band include reference signals #A1 to #A4, and the reference signals on the first frequency band include reference signals #B1 to #B20, where the reference signal #A1 has an association relationship with the reference signals #B1 to #B5, and the coverage range of the reference signals #A1 sequentially covers the coverage ranges of the reference signals #B1 to #B5; the reference signal #A2 has an association relationship with the reference signals #B6 to #B10, and the coverage range of the reference signal #A2 sequentially covers the coverage ranges of the reference signals #B6 to #B10; the reference signal #A3 has an association relationship with the reference signals #B11 to #B15, and the coverage range of the reference signal #A3 sequentially covers the coverage ranges of the reference signals #B11 to #B15; and the reference signal #A4 has an association relationship with the reference signals #B16 to #B20, and the coverage range of the reference signal #A4 sequentially covers the coverage ranges of the reference signals #B16 to #B20. It may be determined that the terminal moves to the boundary of the coverage range of the reference signal #A2 (i.e., the second target reference signal in step 2), and the movement direction is from the coverage range of the reference signal #B8 to the coverage range of the reference signal #B6, in a case where the current reference signal configuration information configures the reference signals #A2 and #A3 on the second frequency band, and where the reference signal with the best measurement result on the first frequency band changes from the reference signal #B8 to the reference signal #B6 (i.e., the first target reference signal in step 2). In this case, it may be determined that the terminal may move into the coverage range of the reference signal #A1 (i.e., the third target reference signal in step 2) on the second frequency band in the next time period, and the measurement range of the reference signals on the second frequency band may be determined as at least one of the reference signal #A2 or the reference signal #A1.

From the above-mentioned content, it can be seen that reference signals whose coverage range includes the current position and the next-moment position of the terminal are determined as the measurement range of the reference signals on the second frequency band to ensure precise beam tracking, by determining the second target reference signal and the third target reference signal as the measurement range of the reference signals on the second frequency band.

In an embodiment of the present disclosure, the network device, upon determining the measurement range of the reference signals on the second frequency band, may determine updated reference signal configuration information based on the measurement range of the reference signals on the second frequency band, and send the updated reference signal configuration information to the terminal, enabling the terminal to receive, based on the updated reference signal configuration information, reference signals configured by the updated reference signal configuration information, measure the reference signals, and then, report measurement results to the network device. As a result, the network device may determine a target beam with the highest quality based on the measurement results, reported by the terminal, of the reference signals on one or more frequency bands, and indicate the target beam to the terminal, allowing for transmission between the terminal and the network device through the target beam, and ensuring the transmission quality between the network device and the terminal. For detailed introductions on how the terminal receives and measures the reference signals based on the reference signal configuration information, reference may be made to the descriptive content in step 202.

In an embodiment of the present disclosure, the updated reference signal configuration information determined by the network device based on the measurement range of the reference signals on the second frequency band may include at least one of the following:
reference signal configuration information corresponding to reference signals within the measurement range of the reference signals on the second frequency band; or
configuration information corresponding to other reference signals having an association relationship with the reference signals within the measurement range of the reference signals on the second frequency band.

According to the method for measuring the beam according to the embodiments of the present disclosure, the network device may determine the measurement range of the reference signals on the second frequency band based on the measurement results of the reference signals on the first frequency band. For example, the network device may determine reference signals with better measurement results on the first frequency band based on the measurement results of the reference signals on the first frequency band, to locate an area where beams with higher beam quality are located. Subsequently, the network device may determine, based on the area where the beams with higher beam quality are located, reference signals, whose coverage range overlaps with this area, on the second frequency band as the measurement range of the reference signals on the second frequency band, enabling the terminal to performs further refined measurements on the reference signals in the area where the beams with higher beam quality are located. Then, the network device may select, based on the measurement results of the terminal, a beam with the highest beam quality for signal transmission. As a result, rapid and refined beam tracking and recovery is achieved, and the transmission efficiency and transmission stability of the terminal is enhanced.

FIG. 3a is a schematic flowchart of a method for measuring a beam according to an embodiment of the present disclosure. The method is performed by the network device. As shown in FIG. 3a, the method for measuring the beam may include the following step 301a.

In step 301a, a measurement range of reference signals on the second frequency band is determined based on measurement results of reference signals on the first frequency band.

For a detailed introduction to step 301a, reference may be made to the description in other embodiments.

According to the method for measuring the beam according to the embodiment of the present disclosure, the network device may determine the measurement range of the reference signals on the second frequency band based on the measurement results of the reference signals on the first frequency band. For example, the network device may determine reference signals with better measurement results on the first frequency band based on the measurement results of the reference signals on the first frequency band, to locate an area where beams with higher beam quality are located. Subsequently, the network device may determine, based on the area where the beams with higher beam quality are located, reference signals, whose coverage range overlaps with this area, on the second frequency band as the measurement range of the reference signals on the second frequency band, enabling the terminal to performs further refined measurements on the reference signals in the area where the beams with higher beam quality are located. Then, the network device may select, based on the measurement results of the terminal, a beam with the highest beam quality for signal transmission. As a result, rapid and refined beam tracking and recovery is achieved, and the transmission efficiency and transmission stability of the terminal is enhanced.

FIG. 3b is a schematic flowchart of a method for measuring a beam according to an embodiment of the present disclosure. The method is performed by the network device. As shown in FIG. 3b, the method for measuring the beam may include the following step 301b.

In step 301b, indication information is sent to the terminal, where the indication information is configured to indicate to-be-measured reference signals, and the to-be-measured reference signals are part or all of reference signals configured by the at least two pieces of reference signal configuration information.

For a detailed introduction to step 301b, reference may be made to the description in other embodiments.

According to the method for measuring the beam according to the embodiment of the present disclosure, the network device may determine the measurement range of the reference signals on the second frequency band based on the measurement results of the reference signals on the first frequency band. For example, the network device may determine reference signals with better measurement results on the first frequency band based on the measurement results of the reference signals on the first frequency band, to locate an area where beams with higher beam quality are located. Subsequently, the network device may determine, based on the area where the beams with higher beam quality are located, reference signals, whose coverage range overlaps with this area, on the second frequency band as the measurement range of the reference signals on the second frequency band, enabling the terminal to performs further refined measurements on the reference signals in the area where the beams with higher beam quality are located. Then, the network device may select, based on the measurement results of the terminal, a beam with the highest beam quality for signal transmission. As a result, rapid and refined beam tracking and recovery is achieved, and the transmission efficiency and transmission stability of the terminal is enhanced.

FIG. 4 is a schematic flowchart of a method for measuring a beam according to an embodiment of the present disclosure. The method is performed by the network device. As shown in FIG. 4, the method for measuring the beam may include the following step 401.

In step 401, an association relationship between the reference signals on the different frequency bands is determined, where coverage ranges of associated reference signals on the different frequency bands are mutually matched.

For a detailed introduction to step 401, reference may be made to the description in other embodiments.

According to the method for measuring the beam according to the embodiment of the present disclosure, the network device may determine the measurement range of the reference signals on the second frequency band based on the measurement results of the reference signals on the first frequency band. For example, the network device may determine reference signals with better measurement results on the first frequency band based on the measurement results of the reference signals on the first frequency band, to locate an area where beams with higher beam quality are located. Subsequently, the network device may determine, based on the area where the beams with higher beam quality are located, reference signals, whose coverage range overlaps with this area, on the second frequency band as the measurement range of the reference signals on the second frequency band, enabling the terminal to performs further refined measurements on the reference signals in the area where the beams with higher beam quality are located. Then, the network device may select, based on the measurement results of the terminal, a beam with the highest beam quality for signal transmission. As a result, rapid and refined beam tracking and recovery is achieved, and the transmission efficiency and transmission stability of the terminal is enhanced.

FIG. 5 is a schematic flowchart of a method for measuring a beam according to an embodiment of the present disclosure. The method is performed by the network device. As shown in FIG. 5, the method for measuring the beam may include the following step 501.

In step 501, a report configuration is sent to the terminal.

For a detailed introduction to step 501, reference may be made to the description in other embodiments.

According to the method for measuring the beam according to the embodiment of the present disclosure, the network device may determine the measurement range of the reference signals on the second frequency band based on the measurement results of the reference signals on the first frequency band. For example, the network device may determine reference signals with better measurement results on the first frequency band based on the measurement results of the reference signals on the first frequency band, to locate an area where beams with higher beam quality are located. Subsequently, the network device may determine, based on the area where the beams with higher beam quality are located, reference signals, whose coverage range overlaps with this area, on the second frequency band as the measurement range of the reference signals on the second frequency band, enabling the terminal to performs further refined measurements on the reference signals in the area where the beams with higher beam quality are located. Then, the network device may select, based on the measurement results of the terminal, a beam with the highest beam quality for signal transmission. As a result, rapid and refined beam tracking and recovery is achieved, and the transmission efficiency and transmission stability of the terminal is enhanced.

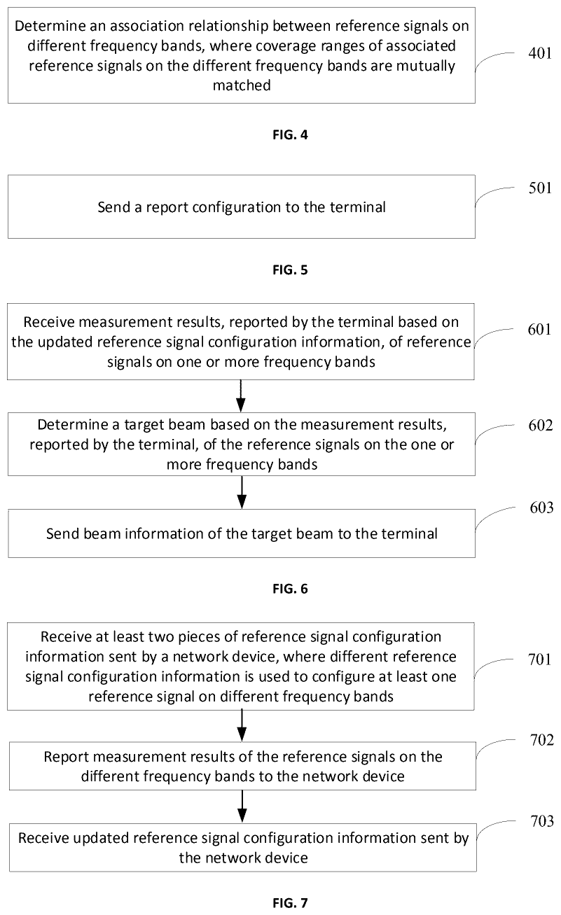

FIG. 6 is a schematic flowchart of a method for measuring a beam according to an embodiment of the present disclosure. The method is performed by the network device. As shown in FIG. 6, the method for measuring the beam may include the following steps 601 to 603.

In step 601, measurement results, reported by the terminal based on the updated reference signal configuration information, of reference signals on one or more frequency bands are received.

In step 602, a target beam is determined based on the measurement results, reported by the terminal, of the reference signals on the one or more frequency bands.

In step 603, beam information of the target beam is sent to the terminal.

In an embodiment of the present disclosure, the beam information of the target beam may include at least one of the following:
a beam index of the target beam; or
transmission configuration indicator state (TCI state) information corresponding to the target beam, such as a TCI state ID.

In an embodiment of the present disclosure, the network device indicates the target beam to the terminal by sending the beam information of the target beam to the terminal.

In an embodiment of the present disclosure, the network device may further configure a TCI state information list for the terminal, in a case where the beam information of the target beam is the TCI state ID corresponding to the target beam. In an example, the TCI state information list includes a corresponding relationship between TCI states and the reference signals. Accordingly, the terminal may query a reference signal corresponding to the TCI state ID in the TCI state information list based on the TCI state ID, upon receiving the TCI state ID corresponding to the target beam sent by the network device. Subsequently, a beam transmitting the reference signal may be determined as the target beam.

In an embodiment of the present disclosure, the terminal may communicate with the network device through the target beam, upon determining the target beam based on the beam information of the target beam.

For a detailed introduction to steps 601 to 603, reference may be made to the description in other embodiments.

According to the method for measuring the beam according to the embodiment of the present disclosure, the network device may determine the measurement range of the reference signals on the second frequency band based on the measurement results of the reference signals on the first frequency band. For example, the network device may determine reference signals with better measurement results on the first frequency band based on the measurement results of the reference signals on the first frequency band, to locate an area where beams with higher beam quality are located. Subsequently, the network device may determine, based on the area where the beams with higher beam quality are located, reference signals, whose coverage range overlaps with this area, on the second frequency band as the measurement range of the reference signals on the second frequency band, enabling the terminal to performs further refined measurements on the reference signals in the area where the beams with higher beam quality are located. Then, the network device may select, based on the measurement results of the terminal, a beam with the highest beam quality for signal transmission. As a result, rapid and refined beam tracking and recovery is achieved, and the transmission efficiency and transmission stability of the terminal is enhanced.

FIG. 7 is a schematic flowchart of a method for measuring a beam according to an embodiment of the present disclosure. The method is performed by a terminal. As shown in FIG. 7, the method for measuring the beam may include the following steps 701 to 703.

In step 701, at least two pieces of reference signal configuration information sent by a network device are received, where different reference signal configuration information is used to configure at least one reference signal on different frequency bands.

In step 702, measurement results of the reference signals on the different frequency bands are reported to the network device.

In an embodiment of the present disclosure, the terminal, upon receiving the at least two pieces of reference signal configuration information sent by the network device, may first receive the reference signals on the different frequency bands based on the at least two pieces of reference signal configuration information, obtains the measurement results by measuring the reference signals on the different frequency bands, and then, reports the measurement results of the reference signals on the different frequency bands to the network device.

In step 703, updated reference signal configuration information sent by the network device is received.

For a detailed introduction to steps 701 to 703, reference may be made to the description in other embodiments.

According to the method for measuring the beam according to the embodiment of the present disclosure, the network device may determine the measurement range of the reference signals on the second frequency band based on the measurement results of the reference signals on the first frequency band. For example, the network device may determine reference signals with better measurement results on the first frequency band based on the measurement results of the reference signals on the first frequency band, to locate an area where beams with higher beam quality are located. Subsequently, the network device may determine, based on the area where the beams with higher beam quality are located, reference signals, whose coverage range overlaps with this area, on the second frequency band as the measurement range of the reference signals on the second frequency band, enabling the terminal to performs further refined measurements on the reference signals in the area where the beams with higher beam quality are located. Then, the network device may select, based on the measurement results of the terminal, a beam with the highest beam quality for signal transmission. As a result, rapid and refined beam tracking and recovery is achieved, and the transmission efficiency and transmission stability of the terminal is enhanced.

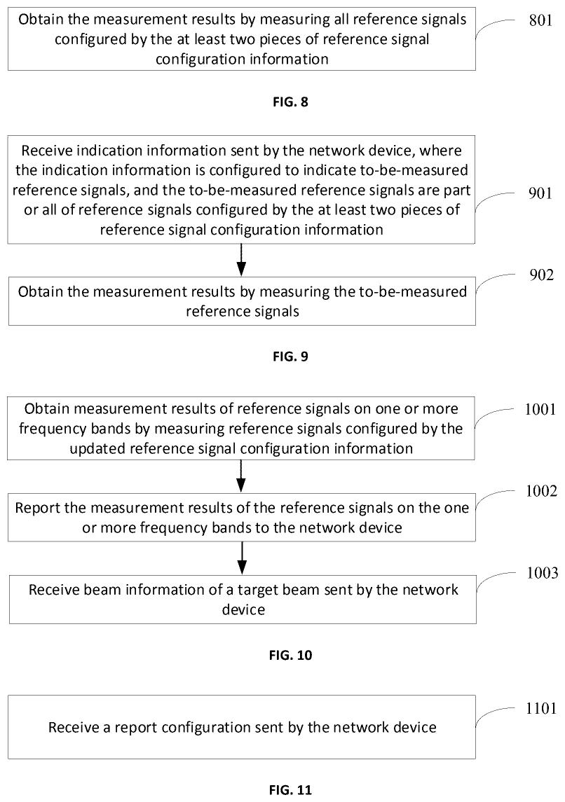

FIG. 8 is a schematic flowchart of a method for measuring a beam according to an embodiment of the present disclosure. The method is performed by the terminal. As shown in FIG. 8, the method for measuring the beam may include the following step 801.

In step 801, measurement results are obtained by measuring all reference signals configured by the at least two pieces of reference signal configuration information.

For a detailed introduction to step 801, reference may be made to the description in other embodiments.

According to the method for measuring the beam according to the embodiment of the present disclosure, the network device may determine the measurement range of the reference signals on the second frequency band based on the measurement results of the reference signals on the first frequency band. For example, the network device may determine reference signals with better measurement results on the first frequency band based on the measurement results of the reference signals on the first frequency band, to locate an area where beams with higher beam quality are located. Subsequently, the network device may determine, based on the area where the beams with higher beam quality are located, reference signals, whose coverage range overlaps with this area, on the second frequency band as the measurement range of the reference signals on the second frequency band, enabling the terminal to performs further refined measurements on the reference signals in the area where the beams with higher beam quality are located. Then, the network device may select, based on the measurement results of the terminal, a beam with the highest beam quality for signal transmission. As a result, rapid and refined beam tracking and recovery is achieved, and the transmission efficiency and transmission stability of the terminal is enhanced.

FIG. 9 is a schematic flowchart of a method for measuring a beam according to an embodiment of the present disclosure. The method is performed by the terminal. As shown in FIG. 9, the method for measuring the beam may include the following steps 901 and 902.

In step 901, indication information sent by the network device is received, where the indication information is configured to indicate to-be-measured reference signals, and the to-be-measured reference signals are part or all of reference signals configured by the at least two pieces of reference signal configuration information.

In step 902, measurement results are obtained by measuring the to-be-measured reference signals.

For detailed introductions to steps 901 and 902, references may be made to the description in other embodiments.

According to the method for measuring the beam according to the embodiment of the present disclosure, the network device may determine the measurement range of the reference signals on the second frequency band based on the measurement results of the reference signals on the first frequency band. For example, the network device may determine reference signals with better measurement results on the first frequency band based on the measurement results of the reference signals on the first frequency band, to locate an area where beams with higher beam quality are located. Subsequently, the network device may determine, based on the area where the beams with higher beam quality are located, reference signals whose coverage range overlaps with this area, on the second frequency band as the measurement range of the reference signals on the second frequency band, enabling the terminal to performs further refined measurements on the reference signals in the area where the beams with higher beam quality are located. Then, the network device may select, based on the measurement results of the terminal, a beam with the highest beam quality for signal transmission. As a result, rapid and refined beam tracking and recovery is achieved, and the transmission efficiency and transmission stability of the terminal is enhanced.

FIG. 10 is a schematic flowchart of a method for measuring a beam according to an embodiment of the present disclosure. The method is performed by the terminal. As shown in FIG. 10, the method for measuring the beam may include the following steps 1001 to 1003.

In step 1001, measurement results of reference signals on one or more frequency bands are obtained by measuring reference signals configured by the updated reference signal configuration information.

In step 1002, the measurement results of the reference signals on the one or more frequency bands are reported to the network device.

In step 1003, beam information of a target beam sent by the network device is received.

For detailed introductions to steps 1001 to 1003, references may be made to the description in other embodiments.

According to the method for measuring the beam according to the embodiment of the present disclosure, the network device may determine the measurement range of the reference signals on the second frequency band based on the measurement results of the reference signals on the first frequency band. For example, the network device may determine reference signals with better measurement results on the first frequency band based on the measurement results of the reference signals on the first frequency band, to locate an area where beams with higher beam quality are located. Subsequently, the network device may determine, based on the area where the beams with higher beam quality are located, reference signal, whose coverage range overlaps with this area, on the second frequency band as the measurement range of the reference signals on the second frequency band, enabling the terminal to performs further refined measurements on the reference signals in the area where the beams with higher beam quality are located. Then, the network device may select, based on the measurement results of the terminal, a beam with the highest beam quality for signal transmission. As a result, rapid and refined beam tracking and recovery is achieved, and the transmission efficiency and transmission stability of the terminal is enhanced.

FIG. 11 is a schematic flowchart of a method for measuring a beam according to an embodiment of the present disclosure. The method is performed by the terminal. As shown in FIG. 11, the method for measuring the beam may include the following step 1101.

In step 1101, a report configuration sent by the network device is received.

For a detailed introduction to step 1101, reference may be made to the description in other embodiments.

According to the method for measuring the beam according to the embodiment of the present disclosure, the network device may determine the measurement range of the reference signals on the second frequency band based on the measurement results of the reference signals on the first frequency band. For example, the network device may determine reference signals with better measurement results on the first frequency band based on the measurement results of the reference signals on the first frequency band, to locate an area where beams with higher beam quality are located. Subsequently, the network device may determine, based on the area where the beams with higher beam quality are located, reference signals, whose coverage range overlaps with this area, on the second frequency band as the measurement range of the reference signals on the second frequency band, enabling the terminal to performs further refined measurements on the reference signals in the area where the beams with higher beam quality are located. Then, the network device may select, based on the measurement results of the terminal, a beam with the highest beam quality for signal transmission. As a result, rapid and refined beam tracking and recovery is achieved, and the transmission efficiency and transmission stability of the terminal is enhanced.

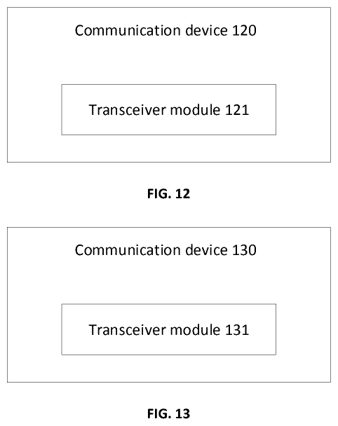

FIG. 12 is a schematic structural diagram of a communication device according to an embodiment of the present disclosure. As shown in FIG. 12, the communication device 120 may include:
a transceiver module 121 configured to send at least two pieces of reference signal configuration information to a terminal, where different reference signal configuration information is used to configure at least one reference signal on different frequency bands;
the transceiver module 121 is further configured to receive measurement results, reported by the terminal, of the reference signals on the different frequency bands; and
the transceiver module 121 is further configured to send updated reference signal configuration information to the terminal, where the updated reference signal configuration information is determined based on a measurement range of reference signals on a second frequency band, the measurement range of the reference signals on the second frequency band is determined based on measurement results of reference signals on a first frequency band, the first frequency band includes at least one frequency band from the different frequency bands, and the second frequency band includes at least one frequency band from the different frequency bands excluding the first frequency band.

According to the communication device according to the embodiment of the present disclosure, the network device may determine the measurement range of the reference signals on the second frequency band based on the measurement results of the reference signals on the first frequency band. For example, the network device may determine reference signals with better measurement results on the first frequency band based on the measurement results of the reference signals on the first frequency band, to locate an area where beams with higher beam quality are located. Subsequently, the network device may determine, based on the area where the beams with higher beam quality are located, reference signals, whose coverage range overlaps with this area, on the second frequency band as the measurement range of the reference signals on the second frequency band, enabling the terminal to performs further refined measurements on the reference signals in the area where the beams with higher beam quality are located. Then, the network device may select, based on the measurement results of the terminal, a beam with the highest beam quality for signal transmission. As a result, rapid and refined beam tracking and recovery is achieved, and the transmission efficiency and transmission stability of the terminal is enhanced.

In an embodiment of the present disclosure, the communication device 120 is further configured to:
determine the measurement range of the reference signals on the second frequency band based on the measurement results of the reference signals on the first frequency band.

In an embodiment of the present disclosure, the reference signal configuration information includes at least one of the following:
a frequency band where the reference signal is located;
a time-domain position of the reference signal;
a frequency-domain position of the reference signal;
sequence information of the reference signal;
an identifier of the reference signal; or
a beam identifier of a transmission beam for the reference signal.

In an embodiment of the present disclosure, the measurement results, reported by the terminal, of the reference signals on the different frequency bands include: measurement results of all reference signals configured by the at least two pieces of reference signal configuration information.

In an embodiment of the present disclosure, the communication device 120 is further configured to:
send indication information to the terminal, where the indication information is configured to indicate to-be-measured reference signals, and the to-be-measured reference signals are part or all of the reference signals configured by the at least two pieces of reference signal configuration information.

In an embodiment of the present disclosure, the measurement results, reported by the terminal, of the reference signals on the different frequency bands include: measurement results of to-be-measured reference signals that are indicated by the indication information.

In an embodiment of the present disclosure, the indication information includes at least one of the following:
a time-domain position of the to-be-measured reference signal;
a frequency-domain position of the to-be-measured reference signal;
an identifier of the to-be-measured reference signal; or
a beam identifier of a transmission beam for the to-be-measured reference signal.

In an embodiment of the present disclosure, the communication device 120 is further configured to:
determine an association relationship between the reference signals on the different frequency bands, where coverage ranges of associated reference signals on the different frequency bands are mutually matched.

In an embodiment of the present disclosure, the first frequency band is lower than the second frequency band, and the transceiver module 121 is further configured to:
determine a reference signal with a measurement result meeting a preset condition on the first frequency band as a target reference signal; and
determine the measurement range of the reference signals on the second frequency band as reference signals, having an association relationship with the target reference signal, on the second frequency band.

In an embodiment of the present disclosure, the first frequency band is higher than the second frequency band, and the transceiver module 121 is further configured to:
determine a reference signal, with a measurement result meeting a preset condition, on the first frequency band as a first target reference signal;
determine, in a case where a distance between a boundary of a coverage range of the first target reference signal and a boundary of a coverage range of a second target reference signal associated with the first target reference signal on the second frequency band is less than a first threshold, a third target reference signal, with a distance between its coverage range and the coverage range of the first target reference signal or the second target reference signal less than a second threshold, on the second frequency band based on an association relationship between the reference signals on the different frequency bands; and
determine the measurement range of the reference signals on the second frequency band as at least one of the second target reference signal on the second frequency band or the third target reference signal on the second frequency band.

In an embodiment of the present disclosure, the communication device 120 is further configured to:
send a report configuration to the terminal.

In an embodiment of the present disclosure, the report configuration includes at least one of the following:
a report condition;
a to-be-measured measurement result; or
a time-frequency resource occupied when reporting the measurement result.

In an embodiment of the present disclosure, the communication device 120 is further configured to:
receive measurement results, reported by the terminal based on the updated reference signal configuration information, of reference signals on one or more frequency bands;
determine a target beam based on the measurement results, reported by the terminal, of the reference signals on the one or more frequency bands; and
send beam information of the target beam to the terminal.

In an embodiment of the present disclosure, the beam information of the target beam includes at least one of the following:
a beam index of the target beam; or
TCI state information corresponding to the target beam.

FIG. 13 is a schematic structural diagram of a communication device according to an embodiment of the present disclosure. As shown in FIG. 13, the communication device 130 may include:
a transceiver module 131 configured to receive at least two pieces of reference signal configuration information sent by a network device, where different reference signal configuration information is used to configure at least one reference signal on different frequency bands;
the transceiver module 131 is further configured to report measurement results of the reference signals on the different frequency bands to the network device; and
the transceiver module 131 is further configured to receive updated reference signal configuration information sent by the network device.

According to the communication device according to the embodiment of the present disclosure, the network device may determine the measurement range of the reference signals on the second frequency band based on the measurement results of the reference signals on the first frequency band. For example, the network device may determine reference signals with better measurement results on the first frequency band based on the measurement results of the reference signals on the first frequency band, to locate an area where beams with higher beam quality are located. Subsequently, the network device may determine, based on the area where the beams with higher beam quality are located, reference signals, whose coverage range overlaps with this area, on the second frequency band as the measurement range of the reference signals on the second frequency band, enabling the terminal to performs further refined measurements on the reference signals in the area where the beams with higher beam quality are located. Then, the network device may select, based on the measurement results of the terminal, a beam with the highest beam quality for signal transmission. As a result, rapid and refined beam tracking and recovery is achieved, and the transmission efficiency and transmission stability of the terminal is enhanced.

In an embodiment of the present disclosure, the communication device 130 is further configured to:
obtain the measurement results by measuring the reference signals on the different frequency bands.

In an embodiment of the present disclosure, the reference signal configuration information includes at least one of the following:
a frequency band where the reference signal is located;
a time-domain position of the reference signal;
a frequency-domain position of the reference signal;
sequence information of the reference signal;
an identifier of the reference signal; or
a beam identifier of a transmission beam for the reference signal.

In an embodiment of the present disclosure, the transceiver module 131 is further configured to:
obtain the measurement results by measuring all reference signals configured by the at least two pieces of reference signal configuration information.

In an embodiment of the present disclosure, the transceiver module 131 is further configured to:
receive indication information sent by the network device, where the indication information is configured to indicate to-be-measured reference signals, and the to-be-measured reference signals are part or all of the reference signals configured by the at least two pieces of reference signal configuration information; and
obtain the measurement results by measuring the to-be-measured reference signals.

In an embodiment of the present disclosure, the indication information includes at least one of the following:
a time-domain position of the to-be-measured reference signal;
a frequency-domain position of the to-be-measured reference signal;
an identifier of the to-be-measured reference signal; or
a beam identifier of a transmission beam for the to-be-measured reference signal.

In an embodiment of the present disclosure, the communication device 130 is further configured to:
obtain measurement results of reference signals on one or more frequency bands by measuring reference signals configured by the updated reference signal configuration information;
report the measurement results of the reference signals on the one or more frequency bands to the network device; and
receive beam information of a target beam sent by the network device.

In an embodiment of the present disclosure, the beam information of the target beam includes at least one of the following:
a beam index of the target beam; or
TCI state information corresponding to the target beam.

In an embodiment of the present disclosure, the communication device 130 is further configured to:
receive a report configuration sent by the network device.

In an embodiment of the present disclosure, the report configuration includes at least one of the following:
a report condition;
a to-be-measured measurement result; or
a time-frequency resource occupied when reporting the measurement result.

In an embodiment of the present disclosure, the transceiver module 131 is further configured to:
obtain a to-be-measured measurement result by measuring the reference signals based on the report configuration; and
the transceiver module 131 is further configured to:
report the measurement result based on the report configuration.

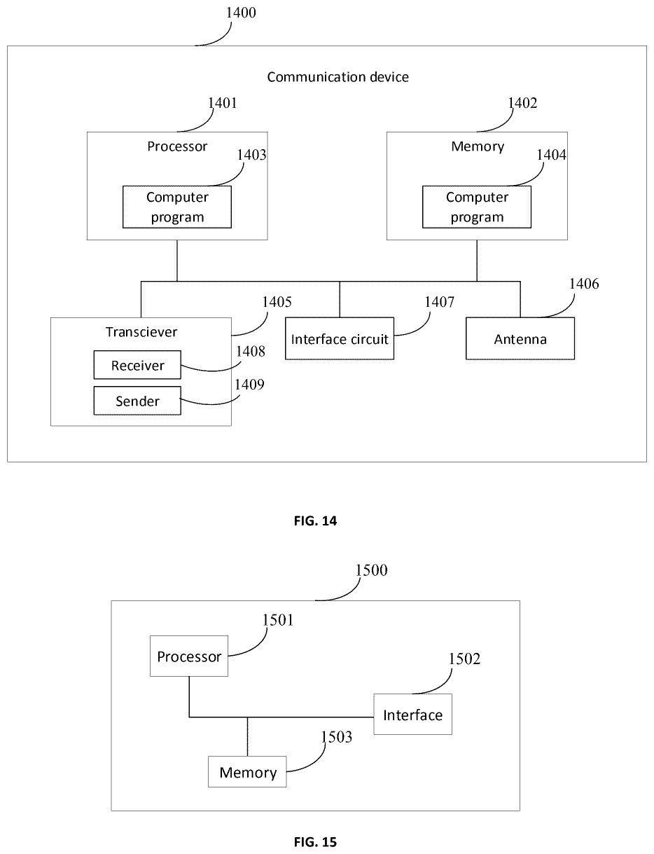

Referring to FIG. 14, FIG. 14 is a schematic structural diagram of a communication device 1400 according to an embodiment of the present disclosure. The communication device 1400 may be a network device or a terminal, may be a chip, chip system, or processor that supports the network device in implementing the methods of the present disclosure, or may further be a chip, chip system, or processor that supports the terminal in implementing the methods of the present disclosure. The communication device 1400 may be configured to perform the methods described in the method embodiments, and reference may be made to the descriptions in the method embodiments for details.

The communication device 1400 may include one or more processors 1401. The processor 1401 may be a general-purpose processor, a dedicated processor, or the like, such as a baseband processor or a central processing unit. The baseband processor may be configured to process communication protocols and communication data. The central processing unit may be configured to control the communication device (e.g., a base station, a baseband chip, a terminal, a terminal chip, a DU, or a CU), execute a computer program, and process data from the computer program.

In an example, the communication device 1400 may include one or more memories 1402 that may store a computer program 1404. The processor 1401 executes the computer program 1404 to cause the communication device 1400 to perform the methods described in the method embodiments. In an example, the memory 1402 may further store data. The communication device 1400 and the memory 1402 may be arranged separately or integrated together.

In an example, the communication device 1400 may further include a transceiver 1405 and an antenna 1406. The transceiver 1405 may be referred to as a transceiver unit, a transmitter machine, a transceiver circuit, or the like, and is configured to implement receiving and sending functions. The transceiver 1405 may include a receiver 1408 and a transmitter 1409. The receiver 1408 may be referred to as a receiving unit, a receiving circuit, or the like, and is configured to implement a receiving function. The transmitter 1409 may be referred to as a sending unit, a sending circuit, or the like, and is configured to implement a sending function.

In an example, the communication device 1400 may also include one or more interface circuits 1406. The interface circuit 1406 is configured to receive code instructions and transmit the code instructions to the processor 1401. The processor 1401 runs the code instructions to cause the communication device 1400 to perform the methods described in the method embodiments.

In an implementation, the processor 1401 may include a transceiver (not shown) for implementing receiving and sending functions. For example, the transceiver may be a transceiver circuit, an interface, or an interface circuit. The transceiver circuit, the interface, or the interface circuit for implementing the receiving and sending functions may be separated or integrated together. The transceiver circuit, the interface, or the interface circuit may be configured for reading and writing code/data, or for transmitting or conveying signals.

In an implementation, the processor 1401 may store a computer program 1403. The computer program 1403, when running on the processor 1401, may cause the communication device 1400 to perform the methods described in the method embodiments. The computer program 1403 may be hard-coded into the processor 1401, and in this case, the processor 1401 may be implemented in hardware.

In an implementation, the communication device 1400 may include a circuit (not shown), and the circuit may implement the sending, receiving, or communication function described in the method embodiments. The processor and the transceiver described in the present disclosure may be implemented on an integrated circuit (IC), an analog IC, a radio frequency integrated circuit (RFIC), a mixed-signal IC, an application specific integrated circuit (ASIC), a printed circuit board (PCB), an electronic device, etc. The processor and the transceiver may also be manufactured using various IC process technologies, such as a complementary metal oxide semiconductor (CMOS), a nmetal-oxide-semiconductor (NMOS), a positive channel metal oxide semiconductor (PMOS), a bipolar junction transistor (BJT), a bipolar CMOS (BiCMOS), silicon germanium (SiGe), and gallium arsenide (GaAs).

The communication device described in the embodiments of the present disclosure may be a network device or a terminal, but the scope of the communication device described in the present disclosure is not limited to these devices. Further, a structure of the communication device may not be limited to that shown in FIG. 14. The communication device may be a standalone device or a part of a larger device. For example, the communication device may be:
(1) a standalone integrated circuit (IC), a chip, a chip system, or a subsystem;
(2) a set with one or more ICs, in an example, the set of ICs may also include a storage component that stores data and a computer program;
(3) an ASIC, such as a modem;
(4) a module that may be embedded within other devices;
(5) a receiver, a terminal, a smart terminal, a cellular phone, a wireless device, a handset, a mobile unit, an in-vehicle device, a network device, a cloud device, an artificial intelligence device, etc.; and
(6) others.

For cases where the communication device is a chip or a chip system, reference may be made to a schematic structural diagram of a chip shown in FIG. 15. The chip 1500 shown in FIG. 15 includes a processor 1501 and an interface 1502. In an example, one or more processor(s) 1501 may be provided, and a plurality of interfaces 1502 may be provided.

In an example, the chip 1500 also includes a memory 1503 that stores a needed computer program and data.

Those skilled in the art may understand that various illustrative logical blocks and steps listed in the embodiments of the present disclosure may be implemented through electronic hardware, computer software, or a combination of both. Whether such functions are implemented in hardware or software depends on particular applications and the design demands of an overall system. Those skilled in the art may use various methods to implement the described functions for each particular application, but such implementations are not to be construed as exceeding the scope of protection of the embodiments of the present disclosure.

The present disclosure further provides a non-transitory computer-readable storage medium storing instructions, where the instructions, when executed by a computer, implement the functions of any of the method embodiments.

The present disclosure further provides a computer program product, where the computer program product, when executed by a computer, implements the functions of any of the method embodiments.

The embodiments of the present disclosure may be fully or partially implemented through software, hardware, firmware, or any combination of them. The embodiments, when implemented using the software, may be fully or partially implemented in the form of the computer program product. The computer program product includes one or more computer programs. The processes or functions described in the embodiments of the present disclosure are fully or partially generated when the computer program is loaded and executed on the computer. The computer may be a general-purpose computer, a dedicated computer, a computer network, or other programmable devices. The computer program may be stored in a non-transitory computer-readable storage medium or transmitted from one non-transitory computer-readable storage medium to another non-transitory computer-readable storage medium. For example, the computer program may be transmitted from one website, computer, server, or data center to another website, computer, computer, server, or data center in a wired (e.g., a coaxial cable, an optical fiber, a digital subscriber line (DSL)) or wireless (e.g., infrared, wireless, and microwave) manner. The non-transitory computer-readable storage medium may be any available medium accessible by the computer or may be a server, a data center, and other data storage devices including one or more available media. The available media may be magnetic media (e.g., floppy disks, hard disks, and magnetic tapes), optical media (e.g., high-density digital video discs (DVDs)), semiconductor media (e.g., solid state disks (SSDs)), or other media.

As used herein, the term “processor” may refer to one processor that performs the defined functions or a plurality of processors that collectively perform defined functions, such that the execution of the individual defined functions may be divided amongst such processors.

Those of ordinary skill in the art may understand that the various numerical symbols such as first and second involved in the present disclosure are merely for convenience of description and are not intended to limit the scope of the embodiments of the present disclosure or imply any sequential order.

The term “at least one” in the present disclosure may also be described as referring to one or more, where “a plurality of” may refer to two, three, four, or more, without limitations in the present disclosure. In the embodiments of the present disclosure, for one type of technical features, the technical features within the type of technical features are distinguished using “first,” “second,” “third,” “A,” “B,” “C,” “D”, etc., and no sequential or hierarchical order exists among the technical features described by “first,” “second,” “third,” “A,” “B,” “C,” and “D”.

Corresponding relationships shown in tables in the present disclosure may be configured or predefined. Values of signals in the tables are merely illustrative and may be configured to other values, which are not limited in the present disclosure. Configuring all corresponding relationships illustrated in the tables is not strictly needed during configuring the corresponding relationship between information and parameters. For example, in the tables of the present disclosure, the corresponding relationships shown in certain rows may not be configured. For another example, appropriate modifications and adjustments may be made based on the tables, such as splitting and merging. Parameter names illustrated in headers of the tables may also be expressed using other names that are comprehensible to the communication device. Values or representations of the parameters may also be other values or representations that are comprehensible to the communication device. Other data structures may also be used when implementing the tables, such as an array, a queue, a container, a stack, a linear list, a pointer, a linked list, a tree, a graph, a struct, a class, a heap, or a hash table.

The term “predefined” in the present disclosure may be understood to be defined, predefined, stored, prestored, pre-negotiated, pre-configured, hard-coded, or pre-burned.

Those of ordinary skill in the art may be aware that the units and algorithmic steps of various examples described in combination with the embodiments disclosed herein may be implemented in electronic hardware or a combination of computer software and electronic hardware. Whether these functions are performed in hardware or software depends on particular applications and design constraint conditions of the technical solution. Technical professionals may use different methods to implement the described functions for each particular application, but such implementations are not to be construed as exceeding the scope of the present disclosure.

Those skilled in the art may clearly understand that, for convenience and brevity of description, the specific operation processes of the system, the device, and the units described above, may refer to the corresponding processes in the method embodiments, and are not redundantly described here.

The descriptions are merely specific implementations of the present disclosure, but are not construed as limiting the scope of protection of the present disclosure. Any modifications or substitutions that would be easily apparent to those skilled in the art, within the technical scope disclosed by the present disclosure, are to be considered as falling within the scope of protection of the present disclosure. Hence, the scope of protection of the present disclosure are to be determined by the scope of protection of the claims.

1. A method for measuring a beam, performed by a network device, the method comprising:
sending at least two pieces of reference signal configuration information to a terminal, wherein different reference signal configuration information is used to configure at least one reference signal on different frequency bands;
receiving measurement results, reported by the terminal, of the at least one reference signal on the different frequency bands; and
sending updated reference signal configuration information to the terminal, wherein the updated reference signal configuration information is determined based on a measurement range of reference signals on a second frequency band, the measurement range of the reference signals on the second frequency band is determined based on measurement results of reference signals on a first frequency band, the first frequency band comprises at least one frequency band from the different frequency bands, and the second frequency band comprises at least one frequency band from the different frequency bands excluding the first frequency band.

2. The method according to claim 1, further comprising:
determining the measurement range of the reference signals on the second frequency band based on the measurement results of the reference signals on the first frequency band.

3. The method according to claim 1, wherein the reference signal configuration information comprises at least one of the following:
a frequency band where the at least one reference signal is located;
a time-domain position of the at least one reference signal;
a frequency-domain position of the at least one reference signal;
sequence information of the at least one reference signal;
an identifier of the at least one reference signal; or
a beam identifier of a transmission beam for the at least one reference signal.

4. The method according to claim 1, wherein the measurement results, reported by the terminal, of the reference signals on the different frequency bands comprise measurement results of all reference signals configured by the at least two pieces of reference signal configuration information.

5. The method according to claim 1, further comprising:
sending indication information to the terminal, wherein the indication information is configured to indicate to-be-measured reference signals, and the to-be-measured reference signals are part or all of the reference signals configured by the at least two pieces of reference signal configuration information;
wherein the measurement results, reported by the terminal, of the reference signals on the different frequency bands comprise measurement results of the to-be-measured reference signals that are indicated by the indication information;
wherein the indication information comprises at least one of the following:
a time-domain position of the to-be-measured reference signals;
a frequency-domain position of the to-be-measured reference signals;
an identifier of the to-be-measured reference signals; or
a beam identifier of a transmission beam for the to-be-measured reference signals.

6-7. (canceled)

8. The method according to claim 1, further comprising:
determining an association relationship between the reference signals on the different frequency bands, wherein coverage ranges of the reference signals having the association relationship on the different frequency bands are mutually matched.

9. The method according to claim 8, wherein the first frequency band is lower than the second frequency band; and determining the measurement range of the reference signals on the second frequency band based on the measurement results of the reference signals on the first frequency band comprises:
determining a reference signal with a measurement result meeting a preset condition on the first frequency band as a target reference signal; and
determining the measurement range of the reference signals on the second frequency band as reference signals having an association relationship with the target reference signal on the second frequency band; or
wherein the first frequency band is higher than the second frequency band; and determining the measurement range of the reference signals on the second frequency band based on the measurement results of the reference signals on the first frequency band comprises:
determining a reference signal with a measurement result meeting a preset condition on the first frequency band as a first target reference signal;
determining, in a case where a distance between a boundary of a coverage range of the first target reference signal and a boundary of a coverage range of a second target reference signal associated with the first target reference signal on the second frequency band is less than a first threshold, a third target reference signal on the second frequency band based on the association relationship between the reference signals on the different frequency bands, wherein a distance between a coverage range of the third target reference signal and the coverage range of the first target reference signal or the second target reference signal is less than a second threshold; and
determining the measurement range of the reference signals on the second frequency band as at least one of the second target reference signal on the second frequency band or the third target reference signal on the second frequency band.

10. (canceled)

11. The method according to claim 1, further comprising:
sending a report configuration to the terminal;
wherein the report configuration comprises at least one of the following:
a report condition;
a to-be-measured measurement result; or
a time-frequency resource occupied when reporting the measurement results.

12. (canceled)

13. The method according to claim 1, further comprising:
receiving measurement results, reported by the terminal based on the updated reference signal configuration information, of reference signals on one or more frequency bands;
determining a target beam based on the measurement results, reported by the terminal, of the reference signals on the one or more frequency bands; and
sending beam information of the target beam to the terminal;
wherein the beam information of the target beam comprises at least one of the following:
a beam index of the target beam; or
transmission configuration indicator (TCI) state information corresponding to the target beam.

14. (canceled)

15. A method for measuring a beam, performed by a terminal, the method comprising:
receiving at least two pieces of reference signal configuration information sent by a network device, wherein different reference signal configuration information is used to configure at least one reference signal on different frequency bands;
reporting measurement results of the at least one reference signal on the different frequency bands to the network device; and
receiving updated reference signal configuration information sent by the network device.

16. The method according to claim 15, wherein the reference signal configuration information comprises at least one of the following:
a frequency band where the at least one reference signal is located;
a time-domain position of the at least one reference signal;
a frequency-domain position of the at least one reference signal;
sequence information of the at least one reference signal;
an identifier of the at least one reference signal; or
a beam identifier of a transmission beam for the at least one reference signal.

17. The method according to claim 15, further comprising:
obtaining the measurement results by measuring the reference signals on the different frequency bands.

18. The method according to claim 17, wherein obtaining the measurement results by measuring the reference signals on the different frequency bands comprises:
obtaining the measurement results by measuring all reference signals configured by the at least two pieces of reference signal configuration information.

19. The method according to claim 17, wherein obtaining the measurement results by measuring the reference signals on the different frequency bands comprises:
receiving indication information sent by the network device, wherein the indication information is configured to indicate to-be-measured reference signals, and the to-be-measured reference signals are part or all of the reference signals configured by the at least two pieces of reference signal configuration information; and
obtaining the measurement results by measuring the to-be-measured reference signals;
wherein the indication information comprises at least one of the following:
a time-domain position of the to-be-measured reference signals;
a frequency-domain position of the to-be-measured reference signals;
an identifier of the to-be-measured reference signals; or
a beam identifier of a transmission beam for the to-be-measured reference signals.

20. (canceled)

21. The method according to claim 15, further comprising:
obtaining measurement results of reference signals on one or more frequency bands by measuring reference signals configured by the updated reference signal configuration information;
reporting the measurement results of the reference signals on the one or more frequency bands to the network device; and
receiving beam information of a target beam sent by the network device;
wherein the beam information of the target beam comprises at least one of the following:
a beam index of the target beam; or
transmission configuration indicator (TCI) state information corresponding to the target beam.

22. (canceled)

23. The method according to claim further comprising:
receiving a report configuration sent by the network device.

24. The method according to claim 23, wherein the report configuration comprises at least one of the following:
a report condition;
a to-be-measured measurement result; or
a time-frequency resource occupied when reporting the measurement results.

25. The method according to claim 23, wherein measuring the reference signals comprises:
obtaining a to-be-measured measurement result by measuring the at least one reference signal based on the report configuration; and
reporting the measurement results comprises:
reporting the measurement results based on the report configuration.

26-27. (canceled)

28. A communication device, comprising one or more processors and a memory, wherein the memory stores a computer program, and the one or more processors, when collectively executing the computer program stored in the memory, cause the communication device to:
send at least two pieces of reference signal configuration information to a terminal, wherein different reference signal configuration information is used to configure at least one reference signal on different frequency bands;
receive measurement results, reported by the terminal, of the at least one reference signal on the different frequency bands; and
send updated reference signal configuration information to the terminal, wherein the updated reference signal configuration information is determined based on a measurement range of reference signals on a second frequency band, the measurement range of the reference signals on the second frequency band is determined based on measurement results of reference signals on a first frequency band, the first frequency band comprises at least one frequency band from the different frequency bands, and the second frequency band comprises at least one frequency band from the different frequency bands excluding the first frequency band.

29-30. (canceled)

31. A communication device, comprising one or more processors and a memory, wherein the memory stores a computer program, and the one or more processors, when collectively executing the computer program stored in the memory, cause the communication device to perform the method according to claim 15.
